(19) United States
(12) Patent Application Publication
(10) Pub. No.: US 2004/0140228 A1
(43) Pub. Date: Jul. 22, 2004

(54) Method for determining an amount of a component in a mixture without calibration

(76) Inventors: Avinash Dalmia, Hamden, CT (US); Otto J. Prohaska, Seymour, CT (US)

Correspondence Address: ST. ONGE STEWARD JOHNSTON & REENS, LLC, 986 BEDFORD STREET, STAMFORD, CT, 06905-5619, US

(21) Appl. No.: 10/345,619

(22) Filed: Jan. 16, 2003

(51) Int. Cl. G01F 1/64; G01N 17/00

(52) U.S. Cl. 205/778.5; 205/780.5; 205/785.5

(57) ABSTRACT

The invention relates to a method for determining an amount of a component in a mixture without calibration, including the steps of oxidizing a component of a mixture of gases to remove electrons from the mixture, measuring a current based upon the removed electrons, and determining an amount of molecules of the component present in the mixture based upon the measured current.

### FIELD OF THE INVENTION

The invention relates to a method for determining an amount of a targeted component in a mixture of gaseous components without requiring instrument calibration.

### BACKGROUND OF THE INVENTION

Generally, instruments, such as electrochemical gas sensors, are used to determine amounts of components present in a gaseous mixture. Electrochemical sensors typically operate at room temperature, provide a signal which varies with concentrations of analyte species, have short response time, and exhibit acceptable sensitivity with high durability. In addition, electrochemical sensors are compact and can be used for continuous monitoring.

Conventional sensor operation typically includes sensor calibration in order to obtain accurate measurements, or readings. Usually, a sensor is calibrated by measuring a signal before introducing the mixture of gases so that a reference point is established from which to measure the gas. Subsequently, another signal is measured after the gas has been introduced and the difference is indicative of the amount of certain components. Hence, two measurements are often needed to determine an amount of a component present in the mixture.

Once a reference point is established, multiple readings may be taken with respect to the same reference point. However, although calibration is not typically performed for each reading, readings requiring sensitivity and accuracy usually entail frequent calibration. This is because reference points of most instruments are known to drift over time. Therefore, new reference points are usually established often to compensate for the drifting and to maintain instrument repeatability and/or accuracy. As a result, calibration generally increases the time and/or cost for making measurements, which in turn increases instrument response time.

Furthermore, when numerous reference points are taken, a standard of deviation, or error, with respect to each reference point is introduced when compared to the whole group of reference points. Hence, calibration, the purpose of which is to maintain sensor accuracy, introduces a counteracting error that negatively affects sensor repeatability. Moreover, simply making measurements without calibration compromises accuracy of the readings.

U.S. Pat. No. 4,343,177 to Carlon et al. relates to an air compensated gas comparison probe that permits air to be drawn across a surface to be monitored and directed onto a sensor element. The invention increases sensitivity and accuracy because conventional probes were limited in its sensitivity due to the effect of air temperature, humidity and environmental trace elements in the air. The presence of such elements negatively changed the sensitivity of the detector and contributed to errors in measurement. Permitting air to be drawn across the sensing surface decreases the negative effects. However, the probe requires calibration. A flow constrictor in the air flow path to one of the sensor elements is used to calibrate the outputs of the two sensor elements under known conditions before attempting to monitor air flow, which may contain a gas to be detected. Similar to conventional probes, two measurements are taken in order to measure the gas. One is taken prior to entry of the gas and one is taken after entry. The difference is indicative of the amount of gas present.

U.S. Pat. No. 4,343,177 to Dolnick et al. and U.S. Pat. No. 5,987,964 to Miremadi are directed to sensors for detecting the presence of a known compound in an unknown mixture of gas. Both are related to sensors having improved sensitivity. However, neither reference discloses, teaches, or suggests a method for detecting compounds without requiring sensor calibration.

What is desired, therefore, is a manner for determining an amount of a gaseous component present in a mixture of gases without calibration. What is further desired is a manner for determining an amount of a gaseous component present in a mixture of gases without compromising accuracy.

### SUMMARY OF THE INVENTION

Accordingly, it is an object of the invention to provide a method for accurately determining a concentration of a gaseous component of a mixture of gases without calibration.

Another object is to efficiently oxidize or reduce a selected gaseous component of a mixture of gases without oxidizing/reducing unselected components.

A further object of the invention is to determine a component's concentration based upon electrons released due to oxidation and/or reduction.

Still a further object of the invention is to improve conditions of the environment in which oxidation/reduction will occur such that efficiency is optimized.

These and other objects of the invention are achieved by provision of a method for determining an amount of a component in a mixture without calibration, including the steps of oxidizing or reducing a component of a mixture of gases to remove electrons from the mixture, measuring a current based upon the removed electrons, and determining an amount of molecules of the component present in the mixture based upon the measured current.

The method further includes the step of calculating a concentration of the component based upon the amount of molecules.

The method receives a selection of a component for analysis and, based upon this selection, oxidizes/reduces and analyzes the selected gas component. In certain embodiments, the method includes suppressing an unselected gas component.

The method efficiently oxidizes/reduces the gas component with an efficiency of between approximately 90%—approximately 100%. The closer to 100%, the more likely accurate concentration determinations will result.

In certain embodiments, improving the environment in which oxidation/reduction occurs results in more accurate concentration determinations. In other embodiments, the method includes consistently introducing a volume of the mixture of gases into the instrument over a consistent amount of time. In further embodiments, the method includes minimizing a volume of gas to be oxidized or reduced.

The invention and its particular features and advantages will become more apparent from the following detailed description considered with reference to the accompanying drawings.

### BRIEF DESCRIPTION OF THE DRAWINGS

FIG. 1 depicts the method in accordance with the invention.

FIG. 2 more particularly depicts the step for oxidizing and/or reducing the gas component.

### DETAILED DESCRIPTION OF THE DRAWINGS

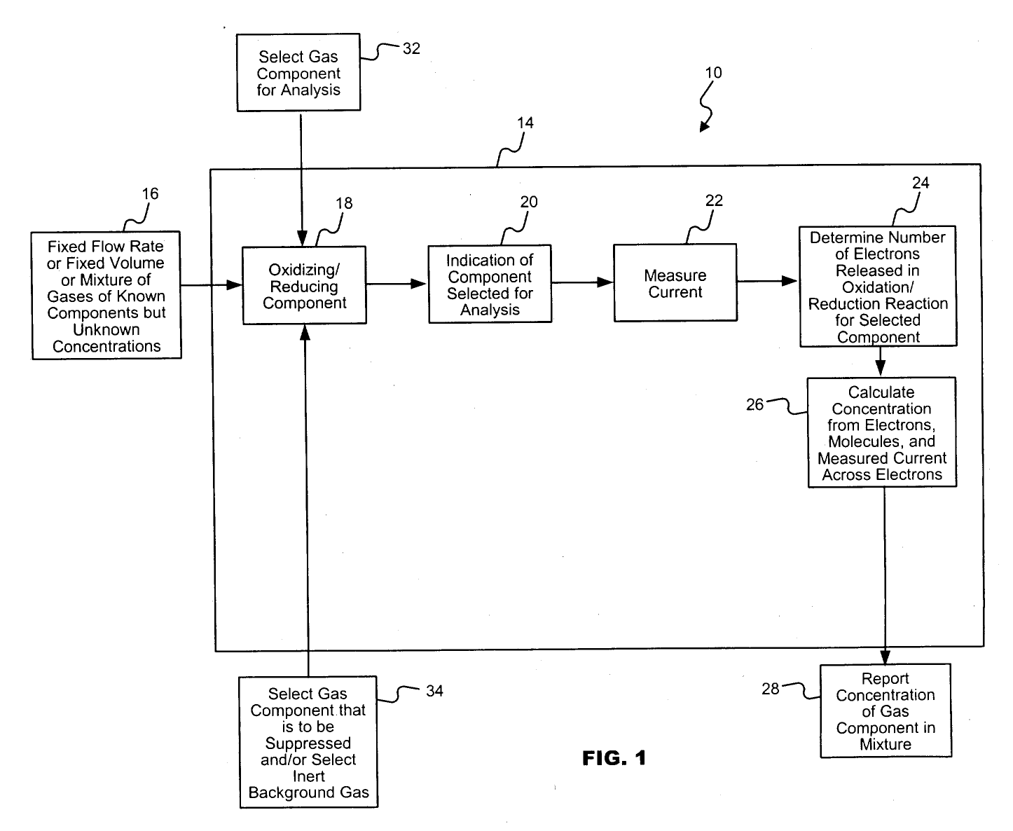

FIG. 1 depicts the method 10 in accordance with the invention. Method 10 shows various steps of the process for determining an amount of a component in a mixture without calibration.

As shown, method 10 utilizes instrument 14 to determine the concentration of a component. In this embodiment, the component to be determined is a gaseous component in a mixture 16 of other gases. In other embodiments, the mixture is a solution where the desired component is transformed into a gaseous state and analyzed according to method 10. In this embodiment, instrument 14 is an electrochemical gas sensor. However, instrument 14 should not be limited to such a sensor but, in other embodiments, may include any device that facilitates determining a concentration of a gas component in a mixture of gases.

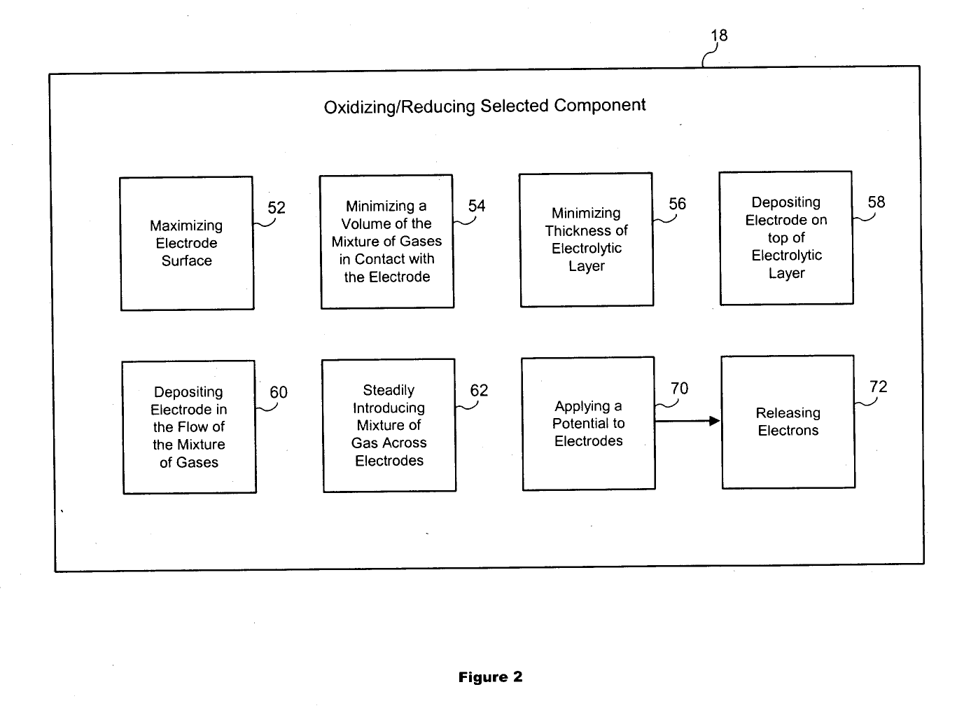

Mixture 16 of gases, which comprises a known volume having known components but an unknown concentration of the desired component, is introduced into instrument 14. After a selection 32 as to the particular gas component to be analyzed has been received by instrument 14, mixture 16 and, more particularly, the desired component to be analyzed are then oxidized and/or reduced 18. FIG. 2 more particularly depicts the step for oxidizing and/or reducing 18 mixture 16.

As a result of oxidation/reduction, electrons are released from mixture 16, the released electrons being an indication 20 of the desired component 20 in a form of current. The measured current is then used for determining 26 concentration of the component. In addition to concentration, method 10 uses the measured current to determine 24 the number of electrons released during oxidation/reduction.

The more efficiently the oxidation/reduction 18, the more likely the electrons released indicate 20 the desired component and the more probable the concentration of the component is determined 26. Method 10 oxidizes/reduces the component to an efficiency of between approximately 90% and approximately 100%. A preferred range for oxidizing/reducing the component is to an efficiency of between approximately 95% and approximately 100%. A more preferred range for oxidizing/reducing the component is between approximately 98% and approximately 100%. The most preferred is to oxidize/reduce the component to 100% or approximately 100% efficiency.

Determining 28 concentration of the component entails using the following formula:

$$I = {I}_{o} exp - ( \frac{DAt}{V δ} ) \qquad formula 1$$

Where I is the current at any time, Iₒ is a current at time=0, A is the surface area of the sensing electrode, t is time, V is the volume of gas in contact with the sensing electrode, D is the diffusion constant, and δ is the electrolytic film thickness.

Integrating formula 1 to obtain a more workable equation, we arrive at

Q=nFCV formula 2

Where Q is the product of current and time, n is a fixed constant representing the number of electrons per molecule, F is the Faraday constant, C is the concentration of the desired component, and V is the volume.

Inserting the measured current into formula 2, where we know volume 16 being introduced into instrument 14, we can solve for the concentration of the desired component C since the remainder of formula B are constants.

In certain embodiments, to verify accuracy, the empirically determined 24 number of electrons is compared with the constant n.

The calculated concentration is then reported 28 using known or novel manners for reporting calculations, such as a digital display, hardcopy, email, or other message indicative of the concentration of gas component in mixture 16.

Formulas 1 and 2 are generally applicable for volumes that are fixed or do not substantially vary over time. For volumes that flow, or that may be described as a flow rate or in terms of volume per unit time, the concentration of the component is determined 28 according to the following formula

I=nFC\dot{V} formula 3

where I, n, F, and C are all described above and \dot{V} is the flow rate, which is measurable such that C may be solved.

Optionally, method 10 includes suppressing 34 unselected gas components whose concentrations are not being determined. Suppression minimizes released electrons from unselected components. Electrons released from unselected components, in addition to the electrons released by the selected gas component, may negatively affect current measurements of the desired component.

In some embodiments, a filter may be used to suppress unselected gas components. In other embodiments, voltage may be varied so that, at a particular voltage, the selected gas component's detection is enhanced while undesired components are suppressed. In further embodiments, certain unselected components are inert and do not react with the sensing electrode.

Although method 10 is described as applicable to an electrochemical gas sensor, it should be known that method 10 is applicable for use with any instrument used for oxidizing/reducing a component of a gaseous mixture. All that is required is for the desired component to be oxidized/reduced such that the measured current is representative of approximately all the electrons released from the desired component. If the desired component is not oxidized/reduced efficiently or substantially, a smaller amount of electrons are released and this negatively affects current measurement, which in turn negatively affects the calculated concentration.

FIG. 2 more particularly depicts the step for oxidizing/reducing 18 the desired component of mixture 16. After receiving a selection 32 of a component for analysis, oxidizing/reducing 18 the component includes applying say we know the component we are analyzing, just not its concentration.

Oxidizing/reducing 18 the selected component includes one or more of the following steps in any order: maximizing 52 an electrode surface, minimizing 54 a volume of the mixture of gas being introduced into the sensor, minimizing 56 a thickness of the electrolytic layer, and strategically placing the sensing electrode in a location that facilitates sensing, such as depositing 58 the electrode on top of the electrolytic layer for direct contact with the gas and depositing 60 the electrode in a flow of the gas.

Maximizing 52 an electrode surface refers to the sensing electrode. In other embodiments, both the sensing and counter electrode surfaces are enlarged. Maximizing 52 the electrode surface increases the sensing area, which facilitates sensing and reacting with gas and, more particularly, the selected gas component. A larger surface area also improves the sensor's response time by reducing the time needed for sensing and reacting with the gas.

Minimizing 54 a volume of the mixture of gas being introduced into the sensor reduces the amount of gas that needs to come in contact with the sensing electrode. Although the selected gas component, as opposed to the entire mixture 16, is desired to come into contact with the sensing electrode, it is difficult to determine where in mixture 16 the selected component is located. Hence, the entire mixture 16 must come in contact with the sensing electrode and, ideally, the selected component will react with the electrode while other components do not react after coming in contact with the sensing electrode.

In addition to, or instead of, minimizing 54 a volume of the mixture of gas, the gas is steadily introduced 62 across the electrodes and, more specifically, the sensing electrode. Consistently introducing 62 mixture 16 across the electrodes facilitates sensing and reacting of the gas component because the entire mixture 16 is moved across the sensing electrode which, as mentioned above, is needed to ensure all of the selected component has come in contact with the electrode surface. If mixture 16 is not introduced 62 across the sensing electrode and remains stagnant, the entire mixture 16 will still come in contact with the sensing electrode via diffusion, or naturally occurring dispersion of the mixture, but such a process is longer than introducing 62 the mixture across the sensing electrode.

In certain embodiments, where the sensing electrode includes an electrolytic layer on the top surface of the electrode for increasing the area of contact between the electrolytic layer, desired component 20, and sensing electrode, minimizing 56 a thickness of the electrolytic layer reduces the time needed for the gas to diffuse through the electrolytic layer and come in contact with the sensing electrode.

As gas diffuses quicker through a thinner electrolytic layer, the response time is minimized and oxidation/reduction of the selected component is facilitated.

In some embodiments, the electrolytic layer is less than 2 micrometers. Ideally, the thickness should be as thin as possible to maximize sensor response time and sensitivity. Hence, in other embodiments, the thickness may be less than 1 micrometer.

The electrolytic layer is in a solid state or dry electrolyte for it has more structural integrity than liquid state electrolyte, thereby permitting a consistently uniform thickness over the sensing electrode. This enhances sensor repeatability and facilitates functionality for liquid state electrolyte would be difficult to maintain in a fixed position on the surface of the sensing electrode.

Another step for facilitating oxidizing/reducing 18 the selected component is to strategically place the sensing electrode in a location that facilitates sensing, such as depositing 58 the electrode on top of the electrolytic layer for direct contact with the gas and depositing 60 the electrode in a path of the flow of the gas.

In certain embodiments of the sensor, the sensing electrode is deposited 58 on top of the electrolytic layer because the gas comes in direct contact with the electrode instead of being diffused through an electrolytic layer, thereby obviating the step for minimizing 56 the thickness of the electrolytic layer for reducing diffusion time.

Depositing 60 the sensing electrode in a flow of the gas, similar to introducing 62 mixture 16 across the sensing electrode, improves sensor response time by facilitating contact between mixture 16 of gas and the sensing electrode, which facilitates sensing and reacting with the selected gas component.

As stated earlier, the above mentioned steps facilitate oxidizing/reducing 18 the selected gas component. In certain embodiments, at least one of the above steps is practiced. In certain other embodiments, more than one of the above steps is practiced to oxidize/reduce 18 the selected component. In certain other embodiments, all the steps are practiced.

Practicing an increasing number of the above steps for oxidizing/reducing 18 the gas component correspondingly enhances oxidation/reduction of the selected component while inhibiting the likelihood that electrons from unselected components will be released. Practicing an increasing number of the above steps also reduces overall sensor response time, resulting in a quicker detection of the concentration of the selected component. Hence, the lower the sensor response time, the better the performance. Generally, the sensor response time may be 60 seconds. A preferred sensor response time is less than 30 seconds. A more preferred sensor response time is less than 10 seconds. An even more preferred sensor response time is less than 5 seconds. A most preferred sensor response time is where the time approaches 0 seconds. The steps may be practiced in any order and, therefore, there is no particular sequence or order for oxidizing/reducing 18 the selected component.

Oxidizing/reducing 18 the selected component further includes applying 70 a predetermined potential to the counter and sensing electrodes such that, when mixture 16 comes in contact with the electrodes, the selected component reacts with the applied potential and releases 72 electrons. Unselected components are less likely to release electrons because the potential is within a range unique to the selected component. Various components of gas mixture 16 release 72 electrons at varying potentials.

Although the invention has been described with reference to a particular arrangements of parts, features and the like, these are not intended to exhaust all possible arrangements or features, and indeed many other modifications and variations will be ascertainable to those of skill in the art.

What is claimed is:

1. A method for determining an amount of a component in a mixture without calibration, comprising the steps of:
oxidizing a component of a mixture of gases to remove electrons from the mixture;
measuring a current based upon the removed electrons; and
determining an amount of molecules of the component present in the mixture based upon the measured current.

2. The method according to claim 1, further comprising the step of calculating a concentration of the component based upon the amount of molecules.

3. The method according to claim 1, further comprising the step of releasing electrons from the gas component to enable current measurement.

4. The method according to claim 1, further comprising the step of reducing the component of the mixture to remove electrons.

5. The method according to claim 1, further comprising the step of suppressing an unselected gas component.

6. The method according to claim 1, further comprising the step of oxidizing the component to an efficiency of between approximately 90%-approximately 100%.

7. The method according to claim 1, further comprising the step of oxidizing the component to an efficiency of between approximately 95%-approximately 100%.

8. The method according to claim 1, further comprising the step of oxidizing the component to an efficiency of between approximately 98%-approximately 100%.

9. The method according to claim 1, further comprising the step of oxidizing the component to an efficiency of approximately 100%.

10. The method according to claim 1, further comprising the step of reducing the component to an efficiency of between approximately 90%-approximately 100%.

11. The method according to claim 1, further comprising the step of reducing the component to an efficiency of between approximately 95%-approximately 100%.

12. The method according to claim 1, further comprising the step of reducing the component to an efficiency of between approximately 98%-approximately 100%.

13. The method according to claim 1, further comprising the step of reducing the component to an efficiency of approximately 100%.

14. The method according to claim 1, further comprising the step of consistently introducing a volume of the mixture of gases into the instrument over a consistent amount of time.

15. The method according to claim 1, further comprising the step of minimizing a volume of gas to be oxidized.

16. A method for determining an amount of a component in a mixture without calibration, comprising the steps of:
minimizing a thickness of an electrolytic layer of an electrochemical gas sensor;
maximizing a surface area of an electrode of the electrochemical gas sensor;
releasing electrons from the volume of gas;
measuring a current based upon the released electrons; and
determining an amount of molecules of a gas component present in the mixture based upon the measured current.

17. The method according to claim 16, further comprising the step of calculating a concentration of the gas component.

18. The method according to claim 16, further comprising the step of minimizing a volume of gas introduced into the sensor.

19. The method according to claim 16, further comprising the step of minimizing a flow rate of the mixture introduced into the sensor.
